(19) United States
(12) Patent Application Publication
(10) Pub. No.: US 2012/0106025 A1
(43) Pub. Date: May 3, 2012

(54) MULTILAYER CERAMIC CAPACITOR AND METHOD OF MANUFACTURING THE SAME

(75) Inventors: Ji Hun JEONG, Suwon (KR); Doo Young Kim, Yongin (KR); Dong Ik Chang, Suwon (KR); Kang Heon Hur, Seongnam (KR); Sung Ae Kim, Suwon (KR)

(73) Assignee: SAMSUNG ELECTRO-MECHANICS CO., LTD.

(21) Appl. No.: 13/116,576

(22) Filed: May 26, 2011

(30) Foreign Application Priority Data
Oct. 29, 2010 (KR) 10-2010-0106877

(51) Int. Cl. H01G 4/30

(52) U.S. Cl. 361/301.4; 29/25.42

(57) ABSTRACT

There is provided a multilayer ceramic capacitor and a method of manufacturing the same. There is provided a multilayer ceramic capacitor, including: a ceramic body having a plurality of dielectric layers stacked therein and including a first side and a second side opposite to each other and a third side and a fourth side connected to the first side and the second side; and inner electrode layers formed on the dielectric layers, including electrode drawing parts exposed to the first side or the second side and an electrode main part, and having a length between the electrode main part and the third side of 100 μm or less and a ratio of a length between the electrode drawing part and the third side to the length between the electrode main part and the third side of between 1.2:1 and 1.7:1. The multilayer ceramic capacitor may have improved reliability by suppressing cracks occurring in the ceramic laminate due to thermal impact during a sintering or mounting process.

### CROSS-REFERENCE TO RELATED APPLICATIONS

This application claims the priority of Korean Patent Application No. 10-2010-0106877 filed on Oct. 29, 2010 in the Korean Intellectual Property Office, the disclosure of which is incorporated herein by reference.

### BACKGROUND OF THE INVENTION

1. Field of the Invention

The present invention relates to a multilayer ceramic capacitor and a method of manufacturing the same, and more particularly, to a multilayer ceramic capacitor having improved reliability by suppressing the occurrence of cracks, and a method of manufacturing the same.

2. Description of the Related Art

Generally, a multi-layered ceramic capacitor (MLCC) is a chip-type capacitor that is mounted on a printed circuit board used in various electronic products such as mobile communications terminals, notebook (or laptop) computers, personal computers, personal digital assistants (PDAs), and the like, to charge and discharge electricity, and has various sizes and stacking types according to the usage and capacity thereof.

Recently, as electronic products have been miniaturized, a demand for compact, high-capacity multi-layered ceramic electronic components has been required. Therefore, various methods of thinning and multi-layering dielectrics and inner electrodes have been attempted. Recently, multi-layered ceramic electronic components having an increased number of thinned dielectric layers therein, have been manufactured.

In a laminate in which ceramic green sheets and inner electrodes are stacked to form several layers, the density of an electrode drawing part may be lower than that of an electrode main and a difference in density therebetween is increased with an increase in the number of stacked layers.

The difference in density causes cracks in the laminate due to a thermal impact applied to the ceramic laminate during a circuit board mounting process through sintering, reflow soldering, or the like.

### SUMMARY OF THE INVENTION

An aspect of the present invention provides a multilayer ceramic capacitor having improved reliability by suppressing occurrence of cracks, and a method of manufacturing the same.

According to an aspect of the present invention, there is provided a multilayer ceramic capacitor, including: a ceramic body having a plurality of dielectric layers stacked therein and including a first side and a second side opposite to each other and a third side and a fourth side connected to the first side and the second side; and inner electrode layers formed on the dielectric layers, including electrode drawing parts exposed to the first side or the second side and an electrode main part, and having a length between the electrode main part and the third side of 100 μm or less and a ratio of a length between the electrode drawing part and the third side to the length between the electrode main part and the third side of between 1.2:1 and 1.7:1.

The dielectric layers may have a thickness of 2 μm or less.

The inner electrode layers may have a thickness of 0.3 to 1.0 μm.

The inner electrode layers may be formed in such a manner that a length between the electrode main part and the fourth side is 100 μm or less and a ratio of a length between the electrode drawing part and the fourth side to the length between the electrode main part and the fourth side is between 1.2:1 and 1.7:1.

According to another aspect of the present invention, there is provided a method of manufacturing a multilayer ceramic capacitor, including: preparing a plurality of dielectric layers having a first side and a second side opposite to each other and a third side and a fourth side connected to the first side and the second side; forming inner electrode layers on the dielectric layers, the inner electrode layers including electrode drawing parts exposed to the first side or the second side and an electrode main part, and having a length between the electrode main part and the third side of 100 μm or less and a ratio of a length between the electrode drawing part and the third side to the length between the electrode main part and the third side of between 1.2:1 and 1.7:1; and preparing a ceramic body by stacking the dielectric layers.

The dielectric layers may have a thickness of 2 μm or less.

The inner electrode layers may have a thickness of 0.3 to 1.0 μm.

The inner electrode layers may be formed in such a manner that a length between the electrode main part and the fourth side is 100 μm or less and a ratio of a length between the electrode drawing part and the fourth side to the length between the electrode main part and the fourth side is between 1.2:1 and 1.7:1.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an exemplary embodiment of the present invention;

FIG. 2 is a cross-sectional view taken along line B-B′ of FIG. 1;

FIG. 3A is a perspective view of dielectric layers having inner electrodes printed thereon according to an exemplary embodiment of the present invention;

FIG. 3B is a plan view of dielectric layers having inner electrodes printed thereon according to an exemplary embodiment of the present invention; and

FIG. 4 is a manufacturing process diagram of a multilayer ceramic capacitor according to an exemplary embodiment of the present invention.

### DETAILED DESCRIPTION OF THE PREFERRED EMBODIMENT

The exemplary embodiments of the present invention may be modified in various forms and the scope of the present invention is not limited to the exemplary embodiments described below. Exemplary embodiments of the present invention are provided so that those skilled in the art may more completely understand the present invention. Accordingly, shapes and sizes of elements in the drawings may be exaggerated for clear description and like reference numerals refer to like elements throughout the drawings.

Exemplary embodiments of the present invention will now be described in detail with reference to the accompanying drawings.

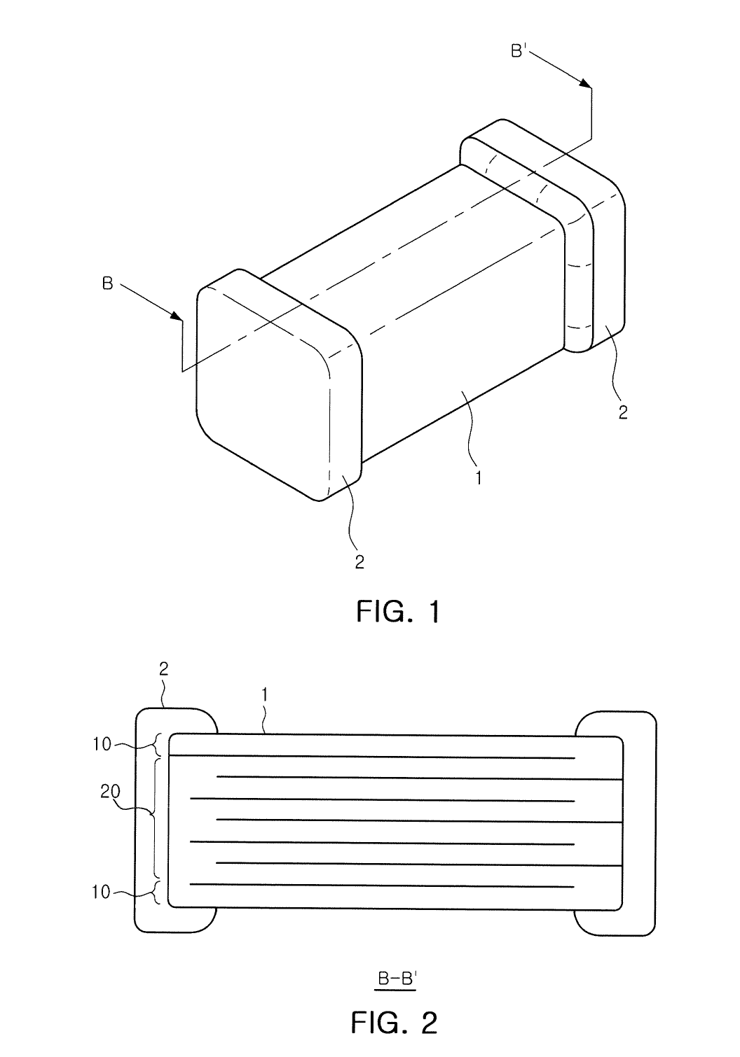

FIG. 1 is a perspective view schematically showing a multilayer ceramic capacitor according to an exemplary embodiment of the present invention.

FIG. 2 is a cross-sectional view taken along line B-B′ of FIG. 1.

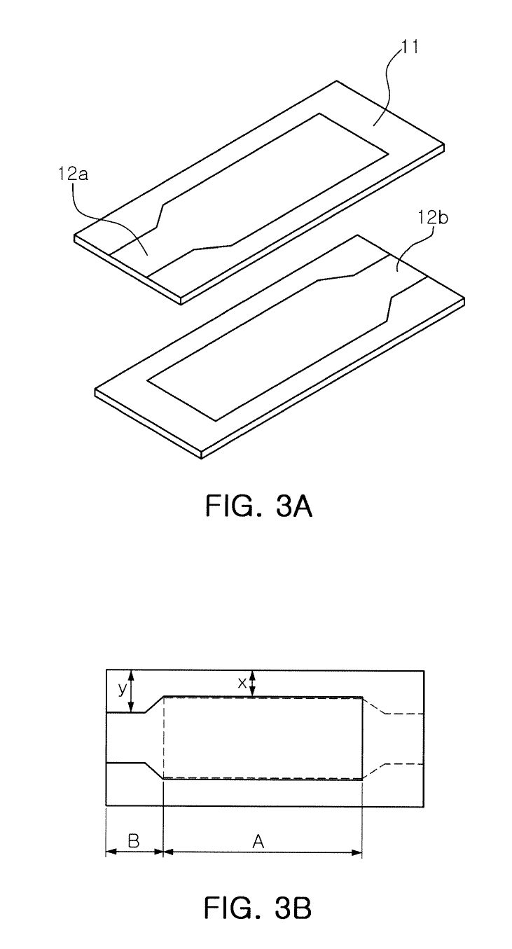

FIG. 3A is a perspective view of dielectric layers having inner electrodes printed thereon according to an exemplary embodiment of the present invention;

FIG. 3B is a plan view of dielectric layers having inner electrodes printed thereon according to an exemplary embodiment of the present invention

Referring to FIGS. 1 and 2, a multilayer ceramic capacitor according to an embodiment of the present invention may be configured to include a capacitor body 1 and outer electrodes 2.

The capacitor body 1 includes a plurality of dielectric layers 11 stacked therein and first inner electrode layers 12a and second inner electrode layers 12b alternately stacked to face each other, having the dielectric layers 11 disposed therebetween.

At this time, the dielectric layers 11 may be made of barium titanate (BaTiO₃) and the first and second inner electrode layers 12a and 12b may be made of nickel (Ni), tungsten (W), cobalt (Co), or the like.

The outer electrodes 2 may be formed on both end surfaces of the capacitor body 1. The outer electrodes 2 are electrically connected to the first and second inner electrode layers 12a and 12b that are exposed externally to end surfaces of the capacitor body 1, thereby serving as external terminals.

In this case, the outer electrodes 2 may be made of copper (Cu).

The multilayer ceramic capacitor according to an exemplary embodiment of the present invention may be configured to include an effective layer 20 in which the dielectric layers 11 and the first and second inner electrode layers 12a and 12b are alternately stacked.

In addition, the multilayer ceramic capacitor may include protective layers 10 formed by stacking the dielectric material layers on the top and bottom surfaces of the effective layer 20.

The protective layers 10 may be formed by continuously stacking a plurality of dielectric material layers in such a manner that the plurality of dielectric material layers have the same thickness on at least one of the top and bottom surfaces of the effective layer 20, preferably, on the top and bottom surfaces thereof, such that the effective layer 20 may be protected from the external impacts, or the like.

The exemplary embodiment of the present invention provides the multilayer ceramic electronic capacitor having improved reliability by suppressing the cracks generated due to the difference in density between the electrode main part contributing to capacity generation and the electrode drawing part not contributing to the capacity generation, in the inner electrode layers within the effective layer 20, and a method of manufacturing the same.

In the exemplary embodiment of the present invention, the electrode main part implies a part that contributes to the capacity generation of the inner electrode layers in the multilayer ceramic electronic components, in particular, the multilayer ceramic capacitor.

Meanwhile, the electrode drawing part, which is a part that does not contribute to the capacity generation of the inner electrode layer, implies an electrode part exposed to a first side or a second side of the ceramic body having the plurality of dielectric layers stacked therein and having the first and second sides opposite to each other and third and fourth sides connected to the first and second sides.

Referring to FIGS. 3A and 3B, the multilayer ceramic capacitor according to an exemplary embodiment of the present invention may have the dielectric layers 11 formed therein and may be configured to include the inner electrode layers 12a and 12b formed in such a manner that a length x between an electrode main part A and the third side is 100 μm or less and a ratio (y:x) of a length y between an electrode drawing part B and the third side to the length x between the electrode main part A and the third side is between 1.2:1 and 1.7:1.

In order to implement the ratio (y:x) of the length y between the electrode drawing part B and the third side to the length x between the electrode main part A and the third side, the ratio may be controlled by controlling the kinds and amount of organic materials such as a binder added during the production of ceramic sheet slurry used for the dielectric layers or controlling the ratio by using subsidiary materials used in the compressing process of hardening the laminate.

Recently, the multilayer ceramic capacitor maximally expands the area of inner electrodes in order to implement capacitance thereof and minimizes the length between each of the electrode main part A and the electrode drawing part B, and the third side or the fourth side. However as a result, cracks tend to be generated in the ceramic laminate.

The density of the electrode drawing part B is the half of that of the electrode main part A and the degree to which the internal electrodes are extended is larger in an effective capacity part, i.e., the electrode main part A.

As a result, the density of the electrode drawing part B is lower than the density of the electrode main part A, thereby causing cracks in the ceramic laminate due to the thermal impact occurring during the sintering or mounting process.

Meanwhile, the cracks due to the thermal impact are increased with the increase of the difference in density between the electrode main part A and the electrode drawing part B.

In the exemplary embodiment of the present invention, the length x between the electrode main part A and the third side is 100 μm or less and the ratio (y:x) of the length y between the electrode drawing part B and the third side to the length x between the electrode main part A and the third side is between 1.2:1 and 1.7:1, thereby suppressing the cracks occurring in the ceramic laminate due to the thermal impact generated during the sintering or the mounting process.

In the exemplary embodiment of the present invention, the length x between the electrode main part A and the third side is 100 μm or less, which is to achieve the aspects of the present invention. When the length x exceeds 100 μm, it is impossible to implement the capacitance of the multilayer ceramic capacitor. As a result, the length x should be set to be 100 μm or less, as described above.

Further, in the exemplary embodiment of the present invention, the ratio (y:x) of the length y between the electrode drawing part B and the third side to the length x between the electrode main part A and the third side is between 1.2:1 and 1.7:1. However, when the ratio (y:x) of the length y between the electrode drawing part B and the third side to the length x between the electrode main part A and the third side is below 1.2:1, it is impossible to achieve the effects of improving delamination and cracks generated due to the thermal impact that are the aspects of the present invention.

In addition, when the ratio exceeds 1.7:1, the size of the inner electrodes of the electrode drawing part B is too small, such that contact efficiency between the inner electrodes and the outer electrodes is degraded, thereby reducing the capacitance of the multilayer ceramic capacitor. Therefore, the ratio needs to be set between 1.2:1 and 1.7:1.

The thickness of the dielectric layer 11 may be formed to be 2 μm or less and the thickness of the inner electrode layers 12a and 12b may be formed to be 0.3 to 1.0 μm.

In addition, the inner electrode layer may be formed in such a manner that the length x between the electrode main part and the fourth side may be 100 μm or less and the ratio of the length between the electrode drawing part and the fourth side to the length x between the electrode main part and the fourth side may be between 1.2:1 and 1.7:1.

Meanwhile, a method of manufacturing a multilayer ceramic capacitor according to another exemplary embodiment of the present invention includes: preparing a plurality of dielectric layers having a first side and a second side opposite to each other and a third side and a fourth side connected to the first side and the second side; forming inner electrode layers on the dielectric layers, the inner electrode layers including electrode drawing parts exposed to the first side or the second side and an electrode main part, and having a length between the electrode main part and the third side of 100 μm or less and a ratio of a length between the electrode drawing part and the third side to the length between the electrode main part and the third side of between 1.2:1 and 1.7:1; and preparing a ceramic body by stacking the dielectric layers.

The thickness of the dielectric layers 11 may be formed to be 2 μm or less and the thickness of the inner electrode layers 12a and 12b may be formed to be 0.3 to 1.0 μm.

In addition, the inner electrode layers may be formed in such a manner that the length x between the electrode main part and the fourth side may be 100 μm or less and the ratio of the length between the electrode drawing part and the fourth side to the length x between the electrode main part and the fourth side may be between 1.2:1 and 1.7:1.

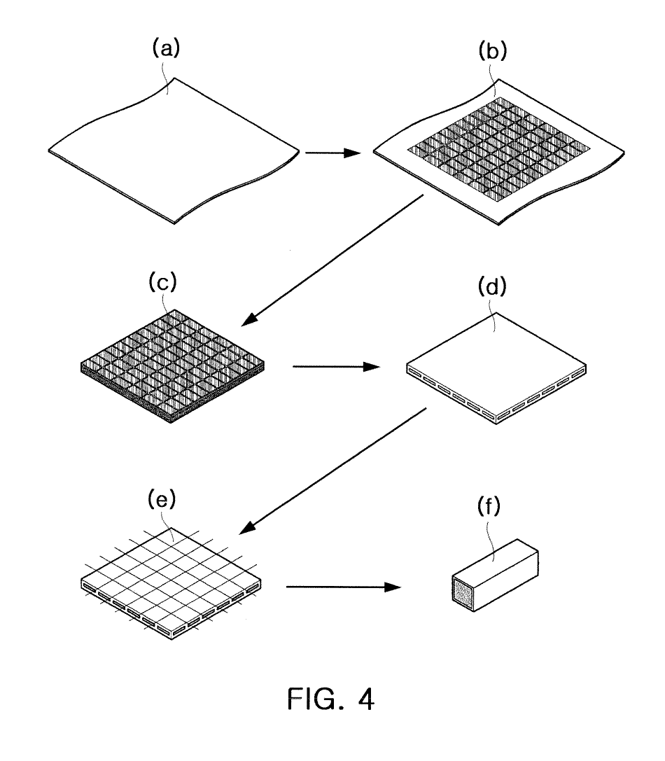

FIG. 4 is a manufacturing process diagram of a multilayer ceramic capacitor according to another exemplary embodiment of the present invention.

First, a step (a) of preparing a plurality of green sheets is performed.

In this case, the green sheets are the ceramic green sheets. Powder such as barium titanate (BaTiO₃) or the like is mixed with a ceramic additive, an organic solvent, a plasticizer, a coupler, and a dispersant to form slurry through the use of a basket mill. Then the slurry is applied to carrier films to be dried, thereby forming dielectric layers having a thickness of several μm, as the green sheets.

Further, a step b of dispensing conductive pastes onto the green sheets and forming inner electrode layers through the dispensing of the conductive pastes while moving a squeegee on the green sheets in a direction is performed.

In this case, the conductive pastes may be made of one of precious metals such as silver (Ag), lead (Pb), platinum, or the like, nickel (Ni), and copper (Cu) or a mixture of at least two materials among the above materials.

According to another exemplary embodiment of the present invention, the thickness of the inner electrode layers may be manufactured to be 0.3 to 1.0 μm.

As described above, after the inner electrode layers are formed, a step c of forming a laminate by separating the green sheets from the carrier films and stacking the plurality of green sheets is performed.

Then, a step f of manufacturing a capacitor body is performed by compressing (d) the green sheet laminate at high temperature and high pressure and then, cutting the compressed green sheet laminate with a predetermined size through a cutting step (e).

The multilayer ceramic capacitor is completed by being subjected to a plasticizing process, a firing process, a polishing process, an outer electrode plating process, or the like.

Hereinafter, exemplary embodiments of the present invention will be described below in more detail with reference to Comparative Examples 1 and 2 and Examples 1 to 4, but is not limited thereto.

Comparative Examples 1 and 2 and Examples 1 to 4 show the multilayer ceramic capacitor manufactured by changing the ratio of the length between the electrode drawing part and the third side to the length between the electrode main part and the third side as described below.

In order to control the ratio of the length between the electrode drawing part and the third side to the electrode main part and the third side, the green ceramic laminate having the length of 100 μm or less between the electrode main part A and the third side is was manufactured.

The inner electrode layer having a printing layer thickness of 0.5 μm is printed by using a screen or gravure printing method, and 500 inner electrode layers printed through the method are stacked and subjected to a compressing process, a cutting process, and an outer electrode plating process.

Other conditions of Comparative Examples 1 and 2 are the same as the Examples 1 to 4. However, the multilayer ceramic capacitor was manufactured in such a manner that the ratio of the length between the electrode drawing part and the third side to the length between the electrode main part and the third side exceeds 1.7:1.

As a result of observing the cross section of the multilayer ceramic capacitor, the length x between the electrode main part A and the third side is 100 μm or less and the ratio of the length of the electrode drawing part and the third side to the length between the electrode main part and the third side is between 1:1 and 2:1.

The capacitance of the manufactured multilayer ceramic capacitor was measured by a meter. It was evaluated whether the cracks occur in the multilayer ceramic capacitor by using a microscope having 50 times to 1000 times magnification after dipping the multilayer ceramic capacitor in a solder pot at 320° C. for 2 seconds.

The following Table 1 shows the result of comparing the capacitance, the delamination occurrence frequency of the ceramic laminate, and the crack occurrence frequency due to the thermal impact with reference to the Examples 1 to 4 and Comparative Examples 1 and 2.

When the ratio of y:x is below 1.2:1, it is difficult to perform the process. As shown in Comparative Examples 1 and 2, when the ratio of y:x is 1.8:1 or more, the size of the inner electrodes of the electrode drawing part is small such that the contact efficiency between the inner electrodes and the outer electrodes is degraded, thereby reducing the capacitance of the multilayer ceramic capacitor.

As a result, when considering the cracks and the capacitance, the appropriate ratio of y:x may be between 1.2:1 and 1.7:1 as shown in Inventive Examples 1 to 4.

TABLE 1

| | | | Delamination | Crack |
|---|---|---|---|---|
| | | | Occurrence | Occurrence |
| | | | Frequency of | Frequency |
| | | Capacitance | Ceramic | Due To |
| No. | Y:X ratio | (μF) | Laminate | Thermal Impact |
| Example 1 | 1.2 | 10.4 | 1/100 | 0/100 |
| Example 2 | 1.3 | 10.3 | 0/100 | 1/100 |
| Example 3 | 1.5 | 10.2 | 1/100 | 0/100 |
| Example 4 | 1.7 | 10.1 | 0/100 | 1/100 |
| Comparative | 1.8 | 9.7 | 1/100 | 4/100 |
| Example 1 | | | | |
| Comparative | 2.0 | 9.3 | 4/100 | 6/100 |
| Example 2 | | | | |

As set forth above, according to the exemplary embodiments of the present invention, the multilayer ceramic capacitor having improved reliability by suppressing cracks occurring in the ceramic laminate due to the thermal impact during the sintering or mounting process could be provided.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor, comprising:
a ceramic body having a plurality of dielectric layers stacked therein and including a first side and a second side opposite to each other and a third side and a fourth side connected to the first side and the second side; and
inner electrode layers formed on the dielectric layers, including electrode drawing parts exposed to the first side or the second side and an electrode main part, and having a length between the electrode main part and the third side of 100 μm or less and a ratio of a length between the electrode drawing part and the third side to the length between the electrode main part and the third side of between 1.2:1 and 1.7:1.

2. The multilayer ceramic capacitor of claim 1, wherein the dielectric layers have a thickness of 2 μm or less.

3. The multilayer ceramic capacitor of claim 1, wherein the inner electrode layers have a thickness of 0.3 to 1.0 μm.

4. The multilayer ceramic capacitor of claim 1, wherein the inner electrode layers are formed in such a manner that a length between the electrode main part and the fourth side is 100 μm or less and a ratio of a length between the electrode drawing part and the fourth side to the length between the electrode main part and the fourth side is between 1.2:1 and 1.7:1.

5. A method of manufacturing a multilayer ceramic capacitor, comprising:
preparing a plurality of dielectric layers having a first side and a second side opposite to each other and a third side and a fourth side connected to the first side and the second side;
forming inner electrode layers on the dielectric layers, the inner electrode layers including electrode drawing parts exposed to the first side or the second side and an electrode main part, and having a length between the electrode main part and the third side of 100 μm or less and a ratio of a length between the electrode drawing part and the third side to the length between the electrode main part and the third side of between 1.2:1 and 1.7:1; and
preparing a ceramic body by stacking the dielectric layers.

6. The method of claim 5, wherein the dielectric layers have a thickness of 2 μm or less.

7. The method of claim 5, wherein the inner electrode layers have a thickness of 0.3 to 1.0 μm.

8. The method of claim 5, wherein the inner electrode layers are formed in such a manner that a length between the electrode main part and the fourth side is 100 μm or less and a ratio of a length between the electrode drawing part and the fourth side to the length between the electrode main part and the fourth side is between 1.2:1 and 1.7:1.
